(19) United States
(12) Patent Application Publication
(10) Pub. No.: US 2006/0114887 A1
(43) Pub. Date: Jun. 1, 2006

(54) Voice communications terminal

(75) Inventor: Shinichi Kashimoto, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/283,791

(22) Filed: Nov. 22, 2005

(30) Foreign Application Priority Data
Nov. 25, 2004 (JP) 2004-340879

(51) Int. Cl. H04L 12/66

(52) U.S. Cl. 370/352

(57) ABSTRACT

To provide a voice communication terminal for executing voice communication via an Internet Protocol network comprises, a presence confirmation request signal transmission unit which transmits a presence confirmation request signal indicating presence of the voice communication terminal to a server connected to the Internet Protocol network, a response time detection unit which detects a response time from the presence confirmation request signal is transmitted until the receipt of a response signal from the server, a communication quality estimation unit which estimates a current communication quality of the Internet Protocol network related to the voice communication in accordance with the response time detected by the detection unit, and a quality information output unit which outputs information on the estimated communication quality.

### CROSS-REFERENCE TO RELATED APPLICATIONS

This application is based upon and claims the benefit of priority from prior Japanese Patent Application No. 2004-340879, filed Nov. 25, 2004, the entire contents of which are incorporated herein by reference.

### BACKGROUND OF THE INVENTION

1. Field of the Invention

The present invention relates to a voice communication terminal for performing voice communication via an Internet Protocol (IP) network.

2. Description of the Related Art

In recent years, a voice over IP (VoIP) technique begun to be put into use so as to transfer voice data by using IP. By using this VoIP technique, an IP telephone system to perform voice communication via an IP network can be achieved. The IP telephone system requires transfer of voice data in real time.

In the IP network, however, fluctuations in transmission delay, losses of voice packets and the like occur. These fluctuations and losses deeply cause reduction in voice quality of the IP telephone system. The IP telephone system, therefore, can enhance the usability of the IP telephone system by achieving a scheme to present, to a user, a current communication quality of the IP network being a rough target for the voice quality.

An Internet telephone system to derive voice packets or the like which have been lost by exchanging the number of a whole of transmitting and receiving packets between two telephone sets is disclosed by Jpn. Pat. Appln. KOKAI Publication No. 2002-185527. In this telephone system, it is necessary to install a specific protocol to exchange the number of the whole of the transmitting and receiving packets into each telephone terminal.

If the specific protocol is installed into communication between the telephone terminals like the system described in the Jpn. Pat. Appln. KOKAI Publication No. 2002-185527, mutual connectivity between the telephone terminals is in risk of deterioration.

A method for quickly reading a link speed from a network interface card respectively provided with each telephone terminal is also known as a simple method for estimating a communication quality of a network. The link speed is, however, a static value decided from the performance of the network interface card, so that it is hard to determine the current, actual communication quality of the IP network.

In the communication terminals using a wireless network interface each, it is conceivable to measure the communication quality of the IP network by utilizing electric field intensity of a radio signal. This measurement method cannot take into account the occurrence of packet losses or the like on the IP network.

### BRIEF SUMMARY OF THE INVENTION

An object of the present invention is to provide a voice communication terminal for executing voice communication via an IP network comprising: a presence confirmation request signal transmission unit configured to transmit a presence confirmation request signal indicating the presence of the voice communication terminal to a server connected to the IP network; a response time detection unit configured to detect a response time (elapsed time) from the transmission of the presence confirmation request signal until the receipt of a response signal from the server; a communication quality estimation unit configured to estimate a current communication quality of the IP network in relation to the voice communication in accordance with the response time detected by the detection unit; and an output unit configured to output information about the estimated communication quality.

### BRIEF DESCRIPTION OF THE SEVERAL VIEWS OF THE DRAWING

FIG. 1 is a view showing a system configuration of a business telephone system using a voice communication terminal regarding an embodiment of the present invention;

FIG. 2 is a block diagram showing a functional configuration of the communication terminal of the embodiment;

FIG. 3 is a block diagram showing a first example of a signaling control module provided with the communication terminal of the embodiment;

FIG. 4 is a view for explaining a transmitting and receiving operation of a presence confirmation request signal and a presence confirmation response signal performed by the communication terminal of the embodiment;

FIG. 5 is a flowchart showing a first example of network quality display processing performed by the communication terminal of the embodiment;

FIG. 6 is a block diagram showing a second example of the functional configuration of the signaling control provided with the communication terminal of the embodiment;

FIG. 7 is a view for explaining packet interpolation processing performed by the communication terminal of the embodiment;

FIG. 8 is a flowchart showing a second example of the network quality display processing performed by the communication terminal of the embodiment;

FIG. 9 is a block diagram showing a third example of the functional configuration of the signaling control module provided with the communication terminal of the embodiment; and

FIG. 10 is a view for explaining network quality display processing during non-voice communication and network quality display processing during voice communication performed by the communication terminal of the embodiment.

### DETAILED DESCRIPTION OF THE INVENTION

Hereinafter, embodiments of the invention will be explained by referring to the drawings.

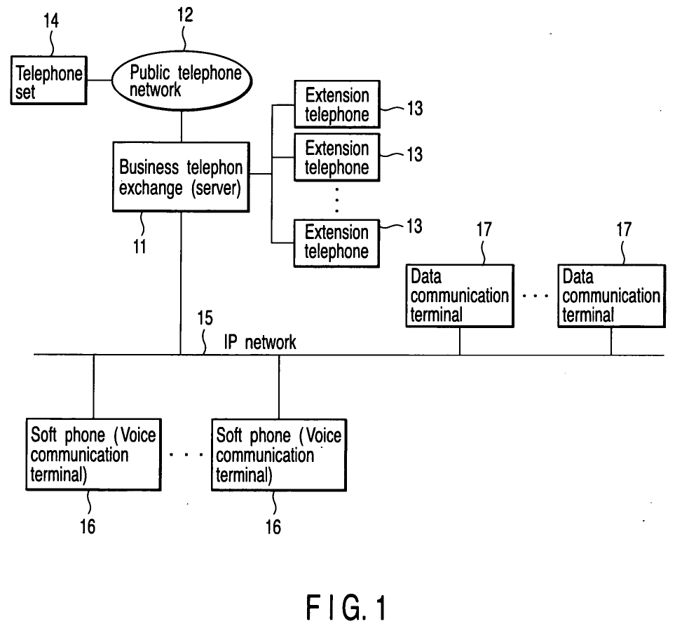

FIG. 1 shows a system configuration of a business telephone system using a voice communication terminal regarding an embodiment of the invention. This business telephone system is an IP telephone system to transfer voice data via an IP network by using a VoIP technique.

This business telephone system, as shown in FIG. 1, has a business telephone exchange 11, a plurality of extension telephone sets 13 and a plurality of soft phones (voice communication terminals) 16. The telephone exchange 11 is one having a VoIP gateway function and has an interface unit to connect to a public telephone network 12 to which a large number of fixed telephone sets (subscription telephone sets) 14 are connected, an interface unit to house the extension telephone sets 13 and an interface unit to connect to an IP network 15.

A plurality of data communication terminals 17 other than the soft phones 16 are connected to the IP network 15. Each data communication terminal 17 is a terminal such as a computer to perform data communication via the IP net work 15. Each soft phone 16 is a voice communication terminal to perform voice communication via the IP network 15. Each soft phone 16 is realized, for example, by software installed on an information processor like a personal computer or a personal digital assistant (PDA). Each soft phone 16 is connected to the IP network 15 via a cable or a wireless network interface.

The telephone exchange (server) 11 functions as a server to manage each soft phone 16 on the IP network 15. That is, the exchange 11 has a function (keep-alive function) to confirm presence statuses of each soft phone 16 and recognize each soft phone 16 on the IP network 15. This keep-alive function is a function required for a server of a usual IP telephone system. The keep-alive function is performed by using a presence confirmation request signal transmitted from each soft phone 16 to the exchange (server) 11. The presence confirmation request signal is a signal to indicate the presence (normal operation) of each soft phone 16 which has transmitted the request signal. The exchange 11 which has received the request signal transmits a response signal (presence confirmation response signal) to each soft phone 16 which has transmitted the request signal.

In this embodiment, each soft phone 16 estimates a current communication quality (network quality) of the IP network 15 related to the voice communication on the basis of the time (response time) from the transmission of the request signal until the receipt of the response signal.

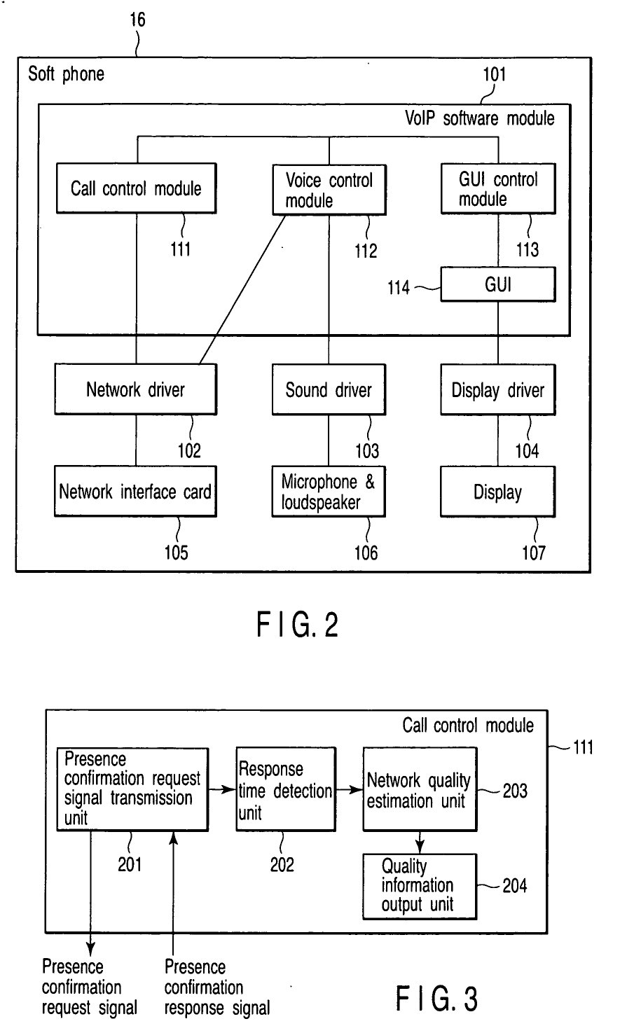

FIG. 2 shows a configuration of each soft phone 16.

An information processor such as a computer acting as each soft phone 16, as shown in FIG. 2, has a VoIP software module 101, a network driver 102, a sound driver 103 and a display driver 104. These VoIP software module 101, network driver 102, sound driver 103 and display driver 104 are achieved through the software executed on the information processor. The information processor has a network interface card 105, an audio input/output unit 106 including a microphone and a loudspeaker and a display unit 107 as hardware. The network interface card 105 is composed of a cable LAN device or a wireless LAN device. Each soft phone 16 is connected to the IP network 15 via a cable or a wireless interface.

The VoIP software module 101 is a software module to perform transmitting and receiving of voice data via the IP network 15 and has a signaling control module 111, a graphical user interface (GUI) control module 113 and a GUI module 114.

The signaling control module 111 of each soft phone 16 transmits and receives a signaling control message between the exchange 11 or other soft phones 16 via the network driver 102 and the network interface card 105.

The voice control module 112 receives the voice signal input from the microphone via the sound driver 103. The voice control module 112 converts received voice signal into voice packets so as to output them. The voice control module 112 transmits each voice packet to a partner terminal (other soft phone, extension telephone set, etc.) through the network driver 102 and the network interface card 105. The voice control module 112 receives each voice packet from the partner terminal though the network driver 102 and the network interface card 105. The voice control module 112 converts the received voice packet into a voice signal in a prescribed format to output the voice signal to the loudspeaker. The voice control module 112 outputs the voice signal as a sound by sending the voice signal to the loudspeaker though the sound driver 103.

The GUI control module 113 controls the display unit 107 through the GUI module 114 and the display driver 104.

FIG. 3 shows an example of a first configuration of the signaling control module 111.

This signaling control module 111 has a presence confirmation request signal transmission unit 201, a response time detection unit 202, a network quality estimation unit 203 and a quality information output unit 204. The request signal transmission unit 201 transmits the presence confirmation request signal indicating the presence of the corresponding soft phone 16 to the exchange 11 via the IP network 15. The request signal transmission unit 201 receives the presence confirmation response signal transmitted from the exchange 11 via the IP network 15. The transmission of the request signal is performed periodically and repeatedly. The exchange 11 transmits the response signals to each of the soft phones 16 which have transmitted the request signals at every receipt of the request signals.

The signaling control module 111 uses the response time detection unit 202, the network quality estimation unit 203 and the quality information output unit 204 so as to present the current communication quality of the IP network 15 in relation to the voice communication. The response time detection unit 202 detects an elapsed time (response time) from the transmission of the request signal from the request signal transmission unit 201 until the receipt of the response signal. The response signal varies in accordance with fluctuations in transmission delay of the IP network 15, reproduction of the response signal and the like. The estimation unit 203 estimates the current communication quality of the IP network 15 in relation to the voice communication in accordance with the detected response time. In particular, the estimation unit 203 estimates the current communication quality on the basis of a statistics amount of the response time detected for each request signal. The quality information output unit 204 outputs information on the estimated communication quality. The information on the communication quality is displayed, for example, onto the display unit 107. The information may be output from the loudspeaker as sound.

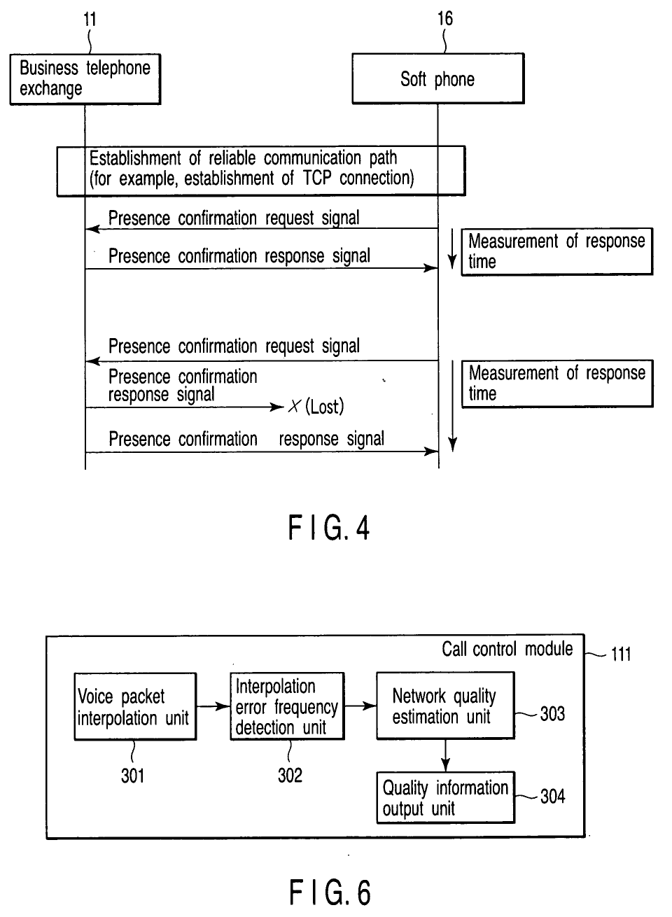

FIG. 4 shows operation sequence of the signaling control module 111.

The signaling control module 111 transmits and receives the request signal and the response signal to and from the exchange 11 by using a communication path with high reliability [for example, transmission control protocol (TCP)] to communicate a signaling control message such as an outgoing or incoming message. The signaling control module 111 measures the response time from the transmission of the request signal until the receipt of the response signal at every transmission of the request signal and estimates the current communication quality of the IP network 15 in relation to the voice communication on the basis of the measured statistics amount of the response time.

If the rate of the cases in which responses return back within 0.5 seconds resulting from, for example, 10 times of the transmission and receipt of the request signals and the response signals is not less than 90%, the signaling control module 111 estimates that the network quality to be a rough target of a voice quality is excellent and displays network quality display information indicating the result of the estimation onto the display unit 107 by a character string or an image. If the network quality is excellent, the signaling control module 111 displays, for example, an image indicating three antennas onto the display unit 107.

If the rate of the cases in which responses return back within 0.5 seconds resulting from the 10 times of the transmission and receipt of the request signals and the response signals is less than 90%, the signaling control module 111 assumes that the possibility of re-transmission of the response signal is high and estimates that a uniform voice quality can not obtain by executing the voice communication in this situation. The signaling control module 111 displays the fact that the network quality is inferior, as the network quality display information by the character string or the image. In this case, for example, the image showing one or two antennas is displayed on the display unit 107.

When the network quality is poor, the signaling control module 111 may notify the fact that the network quality is inferior to a user by reproducing an alert sound in addition to display the fact by the character string or the image.

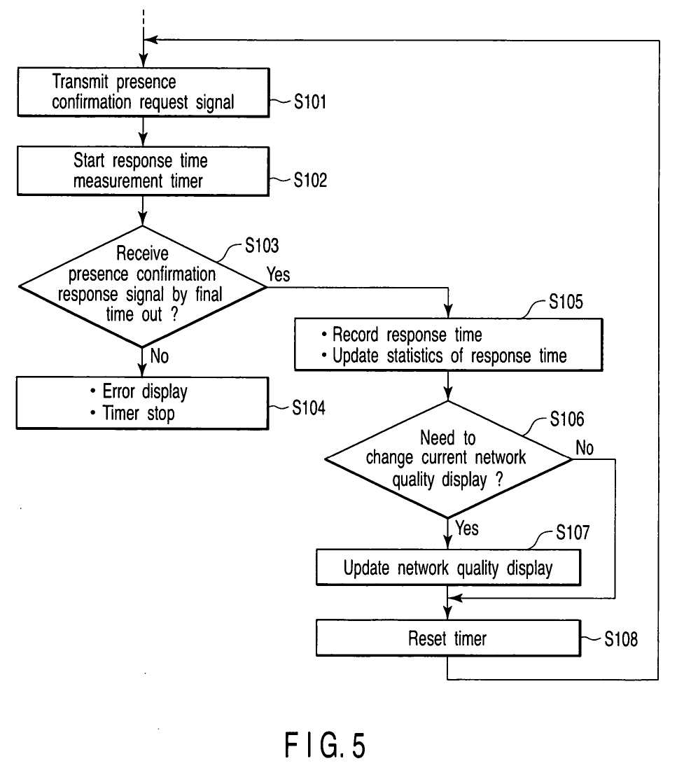

The processing procedures performed by the signaling control module 111 will be explained by referring the flowchart in FIG. 5.

The signaling control module 111 performs the following processing at every transmission of the presence confirmation request signal.

The scaling control module 111 transmits the request signal (step S101) then starts a response time measuring timer (step S102). The signaling control module 111 transmits the request signal then determines whether or not the presence confirmation response signal is received from the time of transmission of the request signal by the time of elapse of a preset final time out time (step S103).

If the response signal is received by the final time out time is passed (Yes, in step S103), the signaling control module 111 records the timer value of the response time measuring timer at the time when the response signal received, as a response time and also updates the statistics amount of the response time (for example, each average, etc., of recorded response time) in accordance with the recorded response time. Next, the signaling control module 111 estimates the current network quality on the basis of the statistics amount of the updated response time and determines whether or not it is necessary to vary the content of the network quality display information which is currently displayed on the display unit 107 (step S106). When the network quality display information showing that the network quality is now excellent, if it is estimated that the network quality is inferior, the control module 111 determines that the content of the network quality display information being currently displayed is should be altered. When the network quality display information showing that the network quality is now inferior, if it is estimated that the network quality is excellent, the control module 111 determines that the contents of the network quality display information being currently displayed is also should be altered.

If it is necessary to alter the content of the display information (Yes, in step S106), the signaling control module 111 updates the content of the display information on the basis of the estimated current network quality (step S107). After this, the signaling control module 111 resets the response time measuring timer and returns the timer value of the measuring timer to an initial value (zero) (step S108).

If the response signal is not received by the elapse of the final time out time (No, in step S103), the signaling control module 111 displays an error message on the display unit 107 and also stops the operation of the measuring timer (step S104).

As described above, by utilizing an existing keep-alive function, it becomes possible to present the current communication quality in relation to the voice communication to the user without degrading mutual connectivity among the voice communication terminals. Since the signaling control module 111 can present the current communication quality to the user before actually starting the voice communication, the signaling control module 111 can preliminarily notify a voice quality of the case in which the voice communication is started to the user by using the soft phone 16.

FIG. 6 shows an example of the second configuration of the signaling control module 111.

This signaling control module 111 has a voice packet interpolation unit 301, an interpolation error frequency detection unit 302, a network quality estimation unit 303 and a quality information output unit 304. During voice communication with other terminals (other soft phones 16 or extension telephone sets 13, etc.), the voice control module 112 receives voice packets transmitted from other terminals via the IP network 15. The voice packet interpolation unit 301 executes interpolation processing to interpolate the lost voice packets by cooperating with the voice control module 112 when the voice packets from other terminals are lost. This interpolation processing is a function needed to the voice communication terminal for the normal IP telephone system. The signaling control module 111 can acquire the voice data corresponding to the lost voice packets. The interpolation processing is carried out, for example, by using specific voice packets which have been prior to the lost voice packets and already received. This interpolation processing function may be provided with the voice control module 112 but not with the signaling control module 111.

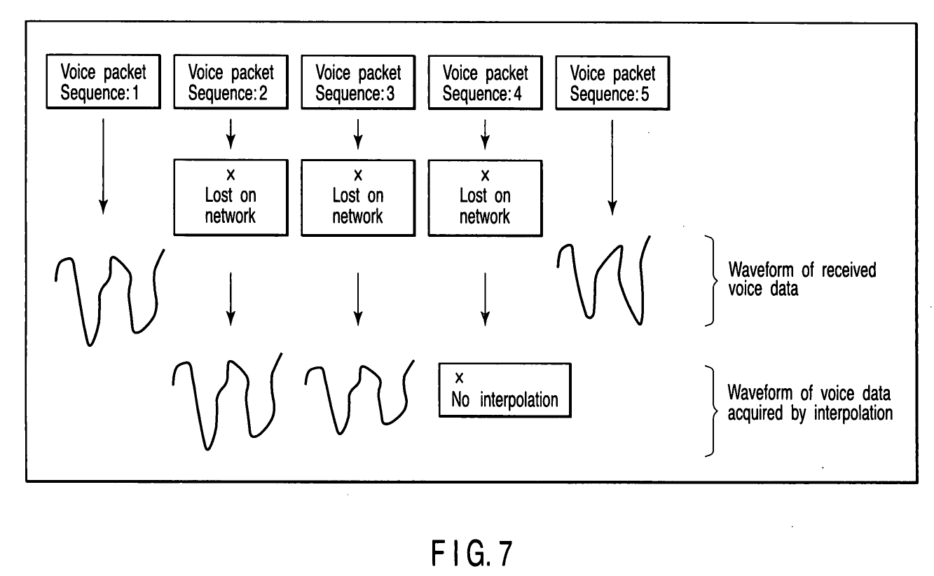

FIG. 7 shows an aspect of the interpolation processing.

Consecutive sequence numbers are put to the voice packets from other terminals, respectively. The voice packet interpolation unit 301 of a terminal on a receiving side can manage the sequence numbers of the received respective voice packets and determines that the voice packets with the next sequence number has been already lost in the case of no arrival of the voice packet with the next sequence number within a prescribed time interval. A method for deciding the limit of time when the voice packet with the next sequence number should arrive can includes, for example, a method that the voice packet should arrive before the completion of the reproduction of the immediately preceding packet. An example of an algorithm of the interpolation processing executed by the voice packet interpolation unit 301 is described as follows.

When the immediately preceding voice packet of the lost voice packets is correctly received, the interpolation unit 301 acquires the lost voice packets by interpolating the lost voice packets by using the corresponding immediately preceding voice packet (the specific voice packet). In this case the voice data of the immediately preceding voice packet is used as the voice data of the lost voice packets.

When two consecutive voice packets are sequentially lost, the second lost voice packet among the two voice packets is interpolated as follows. That is, the second lost voice packet is interpolated by using the voice packet correctly received at two-preceding (specific voice packet). In this case, the voice data which is reduced by 20% (reduction by 20% in height of waveform) of the voice data of the voice packet correctly received at two-preceding is used as the voice data for the lost second voice packet.

Continuous and repeated reproduction of waveforms with the same pattern makes noise. Accordingly, if three or more consecutive voice packets are sequentially lost, the lost voice packets of the third or later are not interpolated. Otherwise stated, losses of the three or more consecutive voice packets become periodical noise by interpolating with the above-mentioned specific voice packet, so that it is determined that the interpolation for those losses is impossible and the interpolation processing is not performed (failure of interpolation processing).

The interpolation error frequency detection unit 302 detects the frequency (interpolation error frequency) of failures of the interpolation processing resulted from the consecution of the losses of the voice packets of the prescribed number (for example, three or more). That is, the detection unit 302 sequentially updates the frequency which could not appropriately interpolate the voice packets which have been assumed as losses.

The network quality estimation unit 303 estimates the current communication quality (network quality) of the IP network 15 related to the voice communication in accordance with the frequency of the failures of the interpolation processing. For example, in the case that a voice frame is 20 msec in length, the estimation unit 303 takes 20 msec to respectively reproduce each voice packet. Accordingly, 500 pieces of voice packets are reproduced for a 10-second time interval. If the frequency in which the received packets assumed as losses could not be appropriately interpolated is, for example, less than 5 times per 10 seconds, the estimation unit 303 estimates that the network quality to be the rough target of the voice quality is excellent. If the frequency in which the received packets assumed to be losses could not be appropriately interpolated is, for example, five or more times per 10 seconds, the estimation unit 303 estimates that the network quality to be the rough target of the voice quality is inferior. The quality information output unit 304 outputs information on the estimated communication quality. The information on the communication quality is displayed by, for example, the character string or the image (number of antennas) on the display unit 107. The estimation unit 303 may output the information in relation to the communication quality as sound from the loudspeaker.

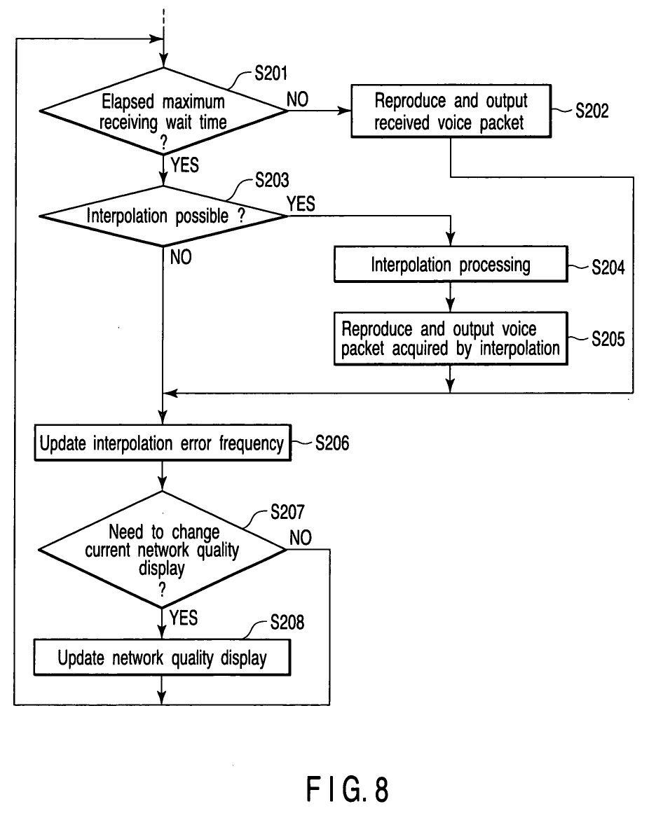

The processing procedures performed by the signaling control module 111 are going to be explained below by referring to the flowchart in FIG. 8.

The signaling control module 111 executes the following processing for each voice packet.

The signaling control module 111 determines whether or not a maximum receiving wait time interval has already elapsed by the time when the next voice packet is received (step S201). The maximum receiving wait time interval is set to, for example, a double value (for example, 40 msec) of a reproduction time of the voice data included in the voice packet. If the signaling control module 111 can receive the next voice packet between the receiving start time of the immediately preceding voice packet and the time when the maximum receiving wait time interval is elapsed (No, in step S201), the voice control module 112 reproduces the received voice packet (step S202). After this, the interpolation error frequency detection unit 302 updates the interpolation error frequency (step S206).

In contrast, if the signaling control module 111 can not receive the next voice packet by the time of the elapse of the maximum receiving wait time interval (Yes, in step S201), the control module 111 determines that the losses of the voice packets have occurred. The control module 111 determines the possibility of the execution of the interpolation processing to the losses of the voice packets (step S203). In this step S203, the control module 111 determines whether or not the losses are those of the three or more consecutive voice packets. If the losses are related to the not less than three consecutive voice packets, the control module 111 determines that the interpolation processing is impossible to be performed because the interpolation by using the above-mentioned specific voice packet makes losses of the three or more consecutive voice packets be the periodical noises (No, in step S203). Then, the control module 111 does not perform the interpolation processing (failure of interpolation processing). After this, the interpolation error frequency detection unit 302 updates the interpolation error frequency (step S206).

In the case of a single loss or losses of tow consecutive voice packets, the control module 111 determines the possibility of the interpolation processing (Yes, in step S203). In this case, the voice interpolation unit 301 performs the interpolation processing by using the specific packet (step S204). The voice control module 112 reproduces the voice packet acquired in this interpolation processing 8 step S205). Then, the interpolation error frequency detection unit 302 updates the interpolation error frequency (step S206).

The signaling control module 111 estimates the current network quality on the basis of the updated interpolation error frequency and determines the necessity of making a change in the contents of the network quality display information currently displayed on the display unit 107 (step S207). In this case, the network quality is estimated in accordance with the fact that the updated interpolation error frequency is larger or not larger than a prescribed value.

Even when the network quality display information indicating that the network quality is superior, if it is estimated that the current network quality is inferior, the control module 111 determines that it is necessary for the contents of the currently displayed network quality display information to be altered. When the network quality information indicating that the network quality is inferior, and if it is estimated that the current network quality is superior, the control module 111 also determines that it is necessary for the contents of the currently displayed network quality information to be altered.

If it is needed to change the contents of the network quality display information (Yes, in step S207), the control module 111 updates the contents of the network quality display information on the basis of the estimated current network quality (step S207).

As stated above, the signaling control module 111 can present the network quality to the user without having to install a specific protocol into the communication among the communication terminals, by utilizing the result of the interpolation processing to the voice packets. Therefore, the control module 111 can present the network quality to be the rough target of the voice quality to the user without degrading the mutual connectivity among the terminals. Since the terminals estimate the network quality from the interpolation error frequency, it is possible to present the network quality information in consideration of further actual voice quality.

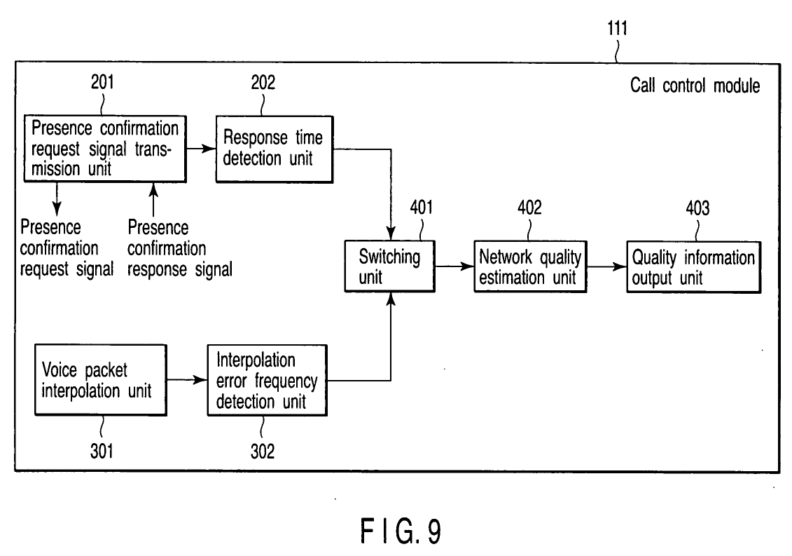

FIG. 9 shows a third example of the signaling control module 111.

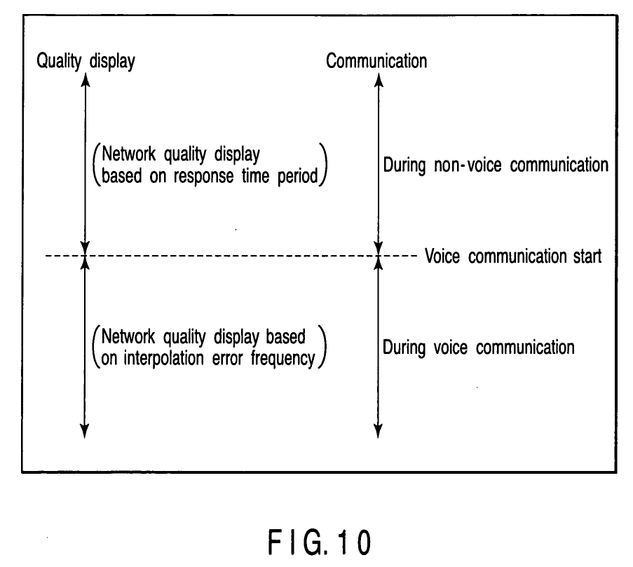

This control module 111 selectively carries out the processing to estimate a network quality on the basis of a statistic amount of a response time and the processing to estimate a network quality on the basis of an interpolation error frequency. In other words, as shown in FIG. 10, during non-voice communication without performing of voice communication, the control module estimates the network quality on the basis of the statistic quantity of the response time and displays the information indicating the estimates network quality. On the other hand, during voice communication with performing of voice communication, the control module 111 estimates the network quality on the basis of the interpolation error frequency and displays the information indicating the estimated network quality.

The signaling control module 111, as shown in FIG. 9, comprises the presence confirmation request signal transmission unit 201, the response time detection unit 202, the voice packet interpolation unit 301, the interpolation error frequency detection unit 302, a switching unit 401, a network quality estimation unit 402 and a quality information output unit 403.

The switching unit 401 determines if the corresponding soft phone 16 is now performing the voice communication. If the voice communication is not performed now, the switching unit 401 selects an output from the response time detection unit 202. In contrast, if the corresponding soft phone 16 is now performing the voice communication, the switching unit 401 selects an output from the interpolation error frequency detection unit 302. The network quality estimation unit 402 estimates, during the non-voice communication, the current communication quality (network quality) of the IP network 15 in relation to the voice communication on the basis of the response time (specifically, statistic quantity of response time) detected by the response time detection unit 202, and estimates, during voice communication, the current communication quality (network quality) of the IP network 15 in relation to the voice communication on the basis of the interpolation error frequency detected by the interpolation error frequency detection unit 302. The quality information output unit 403 displays the information showing the result of the estimation for the network quality by means of a character string or an image (the number of antennas) on the display unit 107. The network quality estimation unit 402 may output the result of the estimation for the network quality by means of a sound signal.

The signaling control module 111 shown in FIG. 9, as described above, displays the network quality on the basis of the statistic quantity of the response time before the start of the voice communication, and displays the network quality on the basis of the interpolation error frequency after the start of the voice communication.

By the way, the whole of the functions of the VoIP software module 101 is realized through a computer program, so that the same effect as that of the foregoing embodiment of the invention can be easily achieved only by installing the VoIP software module 101 in a usual computer having a network function through a computer readable storage medium.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A voice communication terminal for executing voice communication via an Internet Protocol network comprising:
a presence confirmation request signal transmission unit configured to transmit a presence confirmation request signal indicating presence of the voice communication terminal to a server connected to the Internet Protocol network;
a response time detection unit configured to detect a response time from the time when the presence confirmation request signal being transmitted until the time when the response signal from the server being received;
a communication quality estimation unit configured to estimate a current communication quality of the Internet Protocol network in relation to the voice communication in accordance with the response time detected by the response time detection unit; and
a quality information output unit configured to output information on the estimated communication quality.

2. The voice communication terminal according to claim 1, wherein the quality information output unit further includes a display unit configured to display information on the communication quality onto a display device of the voice communication terminal.

3. The voice communication terminal according to claim 1, wherein the quality information output unit further includes an audio unit configured to output information on the communication quality as a sound.

4. The voice communication terminal according to claim 1, wherein the presence confirmation request signal transmission unit repeatedly performs transmission of the presence confirmation request signal, and
the communication quality estimation unit estimates the communication quality on the basis of a statistic quantity of the response times detected for each of the presence confirmation request signal by the detection unit.

5. The voice communication terminal according to claim 1, further comprising:
a voice packet receiving unit for receiving each voice packet transferred from other communication terminals via the Internet Protocol network;
an interpolation unit for executing interpolation processing to interpolate lost voice packets by using a specific voice packet which is prior to the lost voice packets and also already received, when voice packets from the other communication terminals are lost; and
a failure frequency detection unit to detecting frequency of failures of the interpolation processing resulted form consecution of losses of the prescribed number of the voice packets, and
the estimation unit estimates a communication quality in accordance with the detected response time during no execution of the voice communication and estimates a communication quality in accordance with the detected frequency of failures of the interpolation processing during execution of the voice communication.

6. A voice communication terminal for executing voice communication via an Internet Protocol network comprising:
a receiving unit configured to receive each voice packet transferred from other communication terminals via the Internet Protocol network;
an interpolation unit configured to perform interpolation processing to interpolate lost voice packets by using a specific voice packet which is prior to the lost voice packets and also already received, when voice packets from the other communication terminals are lost;
a failure frequency detection unit configured to detect frequency of failures of the interpolation processing resulted from consecution of losses of the prescribed number of the voice packets
a communication quality estimation unit configured to estimate a current communication quality of the Internet Protocol network in relation to the voice communication in accordance with the detected frequency of failures of the interpolation processing; and
a quality information output unit configured to output information related to the estimated communication quality.

7. The voice communication terminal according to claim 6, wherein the quality information output unit has a display unit configured to display the information related to the communication quality onto a display device of the communication terminal.

8. The voice communication terminal according to claim 6, wherein the quality information output unit has an audio unit configured to output the information related to the communication quality as a sound.

9. The voice communication terminal according to claim 6, wherein the estimation unit estimates the current communication quality of the Internet Protocol network in relation to the voice communication in accordance with whether or not the detected frequency is larger than a prescribed value.

10. The voice communication terminal according to claim 6, further comprising:
a presence confirmation request signal transmission unit for transmitting a presence confirmation request signal indicating presence of the voice communication terminal to a server connected to the Internet Protocol network; and
a response time detection unit for detecting a response time from the time when the request signal is transmitted until the time when a response signal from the server is received, and
the communication quality estimation unit estimates a current communication quality of the Internet Protocol network related to the voice communication in accordance with the detected response time during no execution of the voice communication and estimates a current communication quality of the Internet Protocol network related to the voice communication in accordance with the detected frequency of failures of the interpolation processing during execution of the voice communication.

11. A voice communication terminal for executing voice communication via an Internet Protocol network comprising:
means for transmitting a presence confirmation request signal indicating presence of the voice communication terminal to a server connected to the Internet Protocol network;
means for detecting a response time from the time when the presence confirmation request signal being transmitted until the time when the response signal from the server being received;
means for estimating a current communication quality of the Internet Protocol network in relation to the voice communication in accordance with the response time detected by the response time detection unit; and
means for outputting information on the estimated communication quality.

12. The voice communication terminal according to claim 11, wherein the outputting means further includes a display unit configured to display information on the communication quality onto a display device of the voice communication terminal.

13. The voice communication terminal according to claim 11, wherein the outputting means further includes an audio unit for outputting information on the communication quality as a sound.

14. The voice communication terminal according to claim 11, wherein the transmitting means repeatedly performs transmission of the presence confirmation request signal, and
the estimating means estimates the communication quality on the basis of a statistic quantity of the response times detected for each of the presence confirmation request signal by the detection unit.

15. The voice communication terminal according to claim 11, further comprising:
a means for receiving each voice packet transferred from other communication terminals via the Internet Protocol network;
a means for executing interpolation processing to interpolate lost voice packets by using a specific voice packet which is prior to the lost voice packets and also already received, when voice packets from the other communication terminals are lost; and
a means for detecting frequency of failures of the interpolation processing resulted form consecution of losses of the prescribed number of the voice packets, and
the estimating means estimates a communication quality in accordance with the detected response time during no execution of the voice communication and estimates a communication quality in accordance with the detected frequency of failures of the interpolation processing during execution of the voice communication.
